(19) United States
(12) Patent Application Publication
(10) Pub. No.: US 2018/0158002 A1
(43) Pub. Date: Jun. 7, 2018

(54) SECURE METHOD AND SYSTEM FOR VERIFICATION MANAGEMENT AND CONTROL OF EVENT SEAT-RIGHTS

(71) Applicant: SXC Live Inc., Los Angeles, CA (US)

(72) Inventor: Amir AMINI, Los Angeles, CA (US)

(21) Appl. No.: 15/825,695

(22) Filed: Nov. 29, 2017

Related U.S. Application Data
(60) Provisional application No. 62/429,748, filed on Dec. 3, 2016.

(51) Int. Cl. G06Q 10/02; G06Q 30/06; G06K 19/06; H04M 1/725

(52) U.S. Cl. CPC G06Q 10/02; H04M 1/72522; G06K 19/06028; G06Q 30/06

(57) ABSTRACT

A system and method are provided to allow ticket-holders to exchange their verified seat-rights with other ticket-holders, during the event or after the event has started.

### CROSS-REFERENCE TO RELATED APPLICATIONS

This application claims the benefit of U.S. Provisional Application No. 62/429,748, filed on Dec. 3, 2016, entitled SECURE METHOD AND SYSTEM FOR VERIFICATION MANAGEMENT AND CONTROL OF EVENT SEAT-RIGHTS, which is incorporated by reference herein in its entirety.

### TECHNICAL FIELD

The invention is directed to a computer system and, in particular, to systems for verification of real-time seat-rights upon entry into a venue with a ticket when the barcode on the ticket has been invalidated upon entry into the live-event venue.

### BACKGROUND

Often ticket-holders want to exchange their seat-rights with another ticket-holder during an event. Currently, no such market exists for allowing ticket-holders to exchange their seat-rights with other tickets holders, during an event or after the event has started. Venue providers engage Ticket Brokers (known as the primary ticket market) to sell their venue's seats and provide some capability of scanning the ticket upon entry to the event, thereby invalidating the original ticket upon entry. There are other downmarket reseller entities which may act as intermediaries (known as the secondary ticket market) but they all rely on the venue's scanning capability to verify if a ticket has been invalidated (scanned).

Therefore, in today's world, a ticket lifecycle (the period of time in which the ticket still holds value) begins with the venue issuing tickets and ends with the ticket being scanned upon admittance to the event. If the current holder of the seats wishes to exchange his rights to the seat, there is no current system to accommodate that exchange. The availability of such a system would allow any ticket-holders to transact their seat-rights until the end of the event, thereby extending the value lifecycle of a ticket by the event length. Ticket-holders in attendance, as well as brokers and venues with an inventory of unsold tickets would have the capability to derive incremental value from the tickets in their possession.

Furthermore, after a ticket-holder has the barcode on their ticket scanned in order to enter a live-event venue, the barcode is invalidated. There is no mechanism to verify the ticket-holder's seat after they have entered the live-event venue and the ticket's barcode has been invalidated. Thus, if another person inside the venue has a copy of the same ticket, since the barcode has been invalidated, there is no way to tell the difference between the two tickets or which person has the right to use the seat. Therefore, what is needed is a system and method for allowing a ticket-holder's seat-rights to be verified upon and after entry into a venue, especially when the barcode on the ticket has been invalidated after being scanned for entry into the venue. Also, what is needed is a system and method for verification and exchange of seat-rights, during an event, as well as maintaining an authoritative source-of-record for any exchange.

### SUMMARY

In accordance with various aspects of the invention, a system and method are provided for verification and exchange of seat-rights, during an event, as well as maintaining an authoritative source of record of the exchange, which allows for managing any exceptions that might arise.

In accordance with various aspects of the invention, the system and method allow a ticket-holder's seat-rights to be verified at the time of entry, into a venue, by scanning the barcode, such that the scan of the barcode, which invalidates the barcode, activates the verification of the ticket-holder's seat-rights on the mobile device that was used by the ticket-holder to ender venue.

As disclosed herein, real-time, in-event, Peer-to-Peer (ticket-holder), exchange of seats (after barcode has been scanned during entry with verified seat-rights) between ticket-holders is discussed. In accordance with various aspects of the invention, upon agreeing to an exchange, each ticket-holder, on each side of the exchange transaction simultaneously loses access to their verified seat-rights while gaining access to the newly received verified seat-rights in the exchange. In accordance with various aspects of the invention, a transaction log is created with a date and time stamp and details of the exchange transaction, which can be used as a transaction receipt to verify the transfer of seats by the participating ticket-holders as well as the venue provider or any other third parties with a designated need to view final verified seat-rights.

In accordance with various aspects, the invention is embodied in computer systems, such as a server or hardware residing in a server or software executed by hardware. Therefore, the final configuration does not limit the scope of the invention and can be implemented as a computer running software, the software program being one that performs according to the aspects of the invention.

### BRIEF DESCRIPTION OF THE DRAWINGS

The foregoing summary as well as the following detailed description is better understood when read in conjunction with the appended drawings. For the purpose of illustrating the invention, there is shown in the drawings exemplary embodiments in accordance with various aspects of the invention. However, the invention is not limited to the specific embodiments and methods disclosed. In the drawings: For a more complete understanding, reference is now made to the following description taken in conjunction with the accompanying Drawings in which:

FIG. 1 illustrates a block diagram of a wireless communication device used in the various aspects and in at least one embodiment of the invention.

FIG. 2 illustrates a process for seat-right verification and exchange upon entry into an event venue and during that event in accordance with the various aspects and embodiment of the invention.

### DETAILED DESCRIPTION

As will be apparent to those of skill in the art upon reading this disclosure, each of the aspects described and illustrated herein has discrete components and features, which may be readily separated from or combined with the features and aspects to form embodiments, without departing from the scope or spirit of the invention. Any recited method can be carried out in the order of events recited or in any other order which is logically possible. Referring now to the drawings, wherein like reference numbers are used herein to designate like elements throughout, the various views and embodiments of (secure method and system for verification management and control of event seat rights] are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

Unless defined otherwise, all technical and scientific terms used herein have the same meaning as commonly understood by one of ordinary skill in the art to which this invention belongs. Any methods and materials similar or equivalent to those described herein can also be used in the practice of the invention. Representative illustrative methods and materials are also described.

Where a range of values is provided, it is understood that each intervening value between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention. Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Any methods and materials similar or equivalent to those described herein can also be used in the practice of the invention. Representative illustrative methods and materials are also described, but are not intended to limit the scope of the invention, which is defined by the claims that follow.

All statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. It is noted that, as used herein, the singular forms “a,” “an” and “the” include plural referents unless the context clearly dictates otherwise. Reference throughout this specification to “one aspect,” “another aspect,” “one embodiment,” “an embodiment,” “certain embodiment,” or similar language means that a particular aspect, feature, structure, or characteristic described in connection with the embodiment is included in at least one embodiment of the invention. Thus, appearances of the phrases “in one embodiment,” “in at least one embodiment,” “in an embodiment,” “in certain embodiments,” and similar language throughout this specification may, but do not necessarily, all refer to the same embodiment or similar embodiments.

Most users these days carry with themselves devices, such as mobile phones, which are portable and authenticated, with microphones and speakers. For example, mobile phones are tied to a user account through an international mobile station equipment identity (IMEI) code. Somebody sending a phone call or text message to a phone number can trust that the international phone system will route the call or message to that phone number's phone and none other.

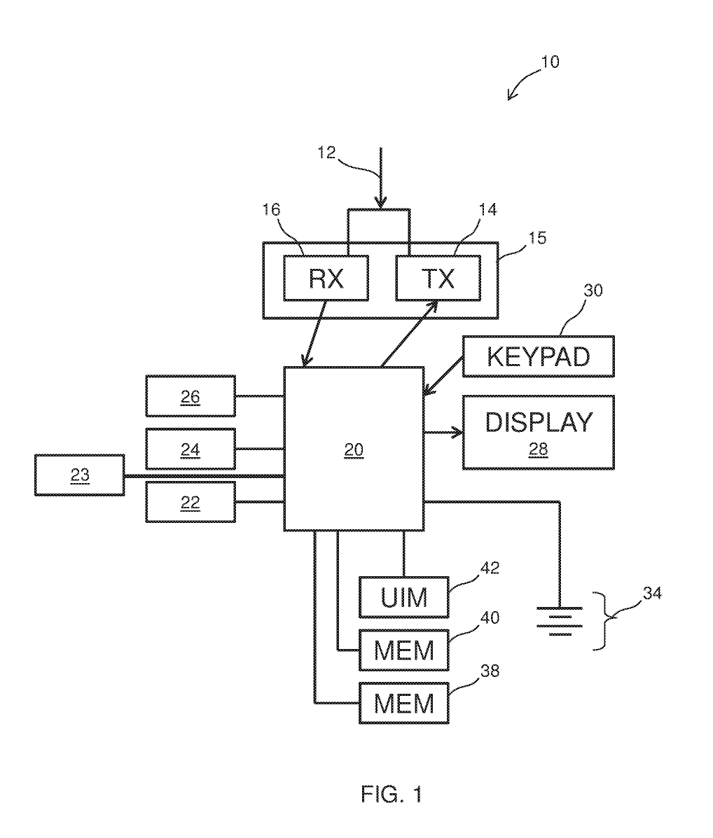

Referring to FIG. 1, based on the various aspects and embodiments of the invention, illustrates a block diagram of a wireless device 10, such as a mobile telephone or a mobile terminal. It should be understood, however, that the wireless device 10, as illustrated and hereinafter described, is merely illustrative of one type of wireless device and/or mobile device that would benefit from embodiments of the invention and, therefore, should not be taken to limit the scope of embodiments of the invention. While several aspects and embodiments of the wireless and mobile device are illustrated and will be hereinafter described for purposes of example, automobiles, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ aspects and embodiments of the invention.

In addition, while wireless device 10 uses several embodiments of the method of the invention, the method may be employed by other than a wireless device or a mobile terminal. Moreover, the system and method of embodiments of the invention will be primarily described in conjunction with mobile communications applications. It should be understood, however, that the invention could be utilized in conjunction with a variety of other applications, both in the mobile communications industries and outside of the mobile communications industries.

The wireless device 10 includes an antenna 12 (or multiple antennae) in operable connection or communication with a transmitter 14 and a receiver 16 in accordance with one aspect of the invention. In accordance with other aspects of the present invention, the transmitter 14 and the receiver 16 may be part of a transceiver 15. The wireless device 10 may further include an apparatus, such as a controller 20 or other processing element, which provides signals to and receives audio segments from the transmitter 14 and receiver 16, respectively. The signals include signaling information in accordance with the air interface standard of the applicable cellular system, and also user speech, received data and/or user generated data. In this regard, the wireless device 10 is capable of operating with one or more air interface standards, communication protocols, modulation types, and access types.

By way of illustration, the wireless device 10 is capable of operating in accordance with any of a number of first, second, third and/or fourth-generation communication protocols or the like. For example, the wireless device 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like. As an alternative (or additionally), the wireless device 10 may be capable of operating in accordance with non-cellular communication mechanisms. For example, the wireless device 10 may be capable of communication in a wireless local area network (WLAN) or other communication networks. The wireless device 10 can also have multiple networking capabilities including nomadic wired tethering, local-area-network transceivers (e.g. IEEE802 Wi-Fi), wide-area-network transceivers (IEEE 802.16 WiMAN/WiMAX, cellular data transceivers, (e.g. LTE) and short-range, data-only wireless protocols such as Ultra-wide-band (UWB), Bluetooth, RFID, Near-field-communications (NFC), etc

It is understood that the apparatus, such as the controller 20, may include circuitry desirable for implementing audio and logic functions of the wireless device 10. For example, the controller 20 may comprise a digital signal processor device, a microprocessor device, and various analog to digital converters, digital to analog converters, and other support circuits. Control and signal processing functions of the wireless device 10 are allocated between these devices according to their respective capabilities. The controller 20 may also include the functionality to encode and interleave message and data prior to modulation and transmission. The controller 20 can additionally include an internal voice coder, and may include an internal data modem. Further, the controller 20 may include functionality to operate one or more software programs, which may be stored in memory, such as speech recognition programs. For example, the controller 20 may be capable of operating a connectivity program, such as a conventional Web browser. The connectivity program may then allow the wireless device 10 to transmit and receive Web content, such as location-based content and/or other web page content, according to a Wireless Application Protocol (WAP), Hypertext Transfer Protocol (HTTP) and/or the like, for example.

The wireless device 10 may also comprise a user interface including an output device such as a conventional earphone or speaker 24, a ringer 22, a camera 23, a microphone 26, a display 28, and at least one user input interface, all of which are coupled to the controller 20. The camera 23 allows the user to capture images and display those images on the display 28. The user input interface, which allows the wireless device 10 to receive data, may include any of a number of devices allowing the wireless device 10 to receive data, such as a keypad 30, a touch display (not shown) or another input device. In embodiments including the keypad 30, the keypad 30 may include the conventional numeric (0-9) and related keys (#, *), and other hard and soft keys used for operating the wireless device 10. Alternatively, the keypad 30 may include a conventional QWERTY keypad arrangement. The keypad 30 may also include various soft keys with associated functions. In addition, or alternatively, the wireless device 10 may include an interface device such as a joystick or another user input interface. The wireless device 10 further includes a battery 34, such as a vibrating battery pack, for powering various circuits that are required to operate the wireless device 10, as well as optionally providing mechanical vibration as a detectable output. Alternatively, or in addition, wireless device 10 may include an energy harvester.

The wireless device 10 may further include a user identity module (UIM) 42. The UIM 42 may be a memory device having a processor built in. The UIM 42 may include, for example, a subscriber identity module (SIM), a universal integrated circuit card (UICC), a universal subscriber identity module (USIM), a removable user identity module (R-UIM), etc. The UIM 42 typically stores information elements related to a mobile subscriber. In addition to the UIM 42, the wireless device 10 may be equipped with memory. For example, the wireless device 10 may include volatile memory 40, such as volatile Random Access Memory (RAM) including a cache area for the temporary storage of data, including captured input audio segments. The wireless device 10 may also include other non-volatile memory 38, which can be embedded and/or may be removable. The non-volatile memory 38 can additionally or alternatively comprise an electrically erasable programmable read only memory (EEPROM), flash memory or the like, such as that available from the SanDisk Corporation of Milpitas, Calif., or Micron Consumer Products Group Inc. of Milpitas, Calif. The memories can store any of a number of pieces of information, and data, used by the wireless device 10 to implement the functions of the wireless device 10. For example, the memories can include an identifier, such as an international mobile equipment identification (IMEI) code, capable of uniquely identifying the wireless device 10. Furthermore, the memories may store instructions for determining cell id information. Specifically, the memories may store an application program for execution by the controller 20, which determines an identity of the current cell, i.e., cell id identity or cell id information, with which the wireless device 10 is in communication.

Although not every element of every possible mobile network is shown and described herein, it should be appreciated that the wireless device 10 may be coupled to one or more of any of a number of different networks through a base station (not shown). In this regard, the network(s) may be capable of supporting communication in accordance with any one or more of a number of first-generation (1G), second-generation (2G), 2.5G, third-generation (3G), 3.9G, fourth-generation (4G), fifth-generation (5G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the invention, as should dual or higher mode mobile stations (e.g., digital/analog or TDMA/CDMA/analog phones).

The wireless device 10 can further be coupled to one or more wireless access points (APs) (not shown). The APs may comprise access points configured to communicate with the wireless device 10 in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs may be coupled to the Internet (not shown). The APs can be directly coupled to the Internet. In accordance with other aspects of the invention, the APs are indirectly coupled to the Internet. Furthermore, in one embodiment, the BS may be considered as another AP

As will be appreciated, by directly or indirectly connecting the wireless devices 10 to the Internet, the wireless device 10 can communicate with other devices, a computing system, etc., to thereby carry out various functions of the wireless device 10, such as to transmit data, content or the like to, and/or receive content, data or the like from other devices.

In accordance with the teachings of the invention, a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, is implemented in a variety of ways: with one or more distinct processors or microprocessors, volatile and/or non-volatile memory and peripherals or peripheral controllers with an integrated microcontroller, which has a processor, local volatile and non-volatile memory, peripherals and input/output pins; discrete logic which implements a fixed version of the article of manufacture or system and programmable logic which implements a version of the article of manufacture or system which can be reprogrammed either through a local or remote interface. Such logic could implement a control system either in logic or via a set of commands executed by a processor.

Although not shown, the wireless device 10 may communicate in accordance with, for example, RF, BT, IrDA or any of a number of different wireline or wireless communication techniques, including LAN, WLAN, WiMAX, UWB techniques and/or the like. One or more of the computing systems that are in communication with the wireless device 10 can additionally, or alternatively, include a removable memory capable of storing content, which can thereafter be transferred to the wireless device 10. Further, the wireless device 10 can be coupled to one or more electronic devices, such as displays, printers, digital projectors and/or other multimedia capturing, producing and/or storing devices (e.g., other terminals). Furthermore, it should be understood that embodiments of the invention may be resident on a communication device such as the wireless device 10, or may be resident on a network device or other devices accessible to the wireless device 10.

In accordance with the various aspects of the invention, the wireless device 10 includes on board location systems. While the on-board location systems (e.g. Global-Navigation-Satellite-System Receivers (GNSS)) may be used to develop a location estimate for the wireless device 10, the location of a wireless device 10 may be determined from the interaction (i.e. radio messaging) between the wires device 10 and the network (e.g. cellular system, WiMAN, WiMAX, WiFi, Bluetooth, NFC), which may be a network present at the venue where the event is taking place.

In accordance with the various aspects of the invention, a system is disclosed that includes the ability to: transmit to and receive information from a wireless device, such as the wireless device 10, via a wireless or wired connection. In accordance with one embodiment and various aspects of the invention, a venue ticketing system may coordinate with a venue where an event is to take place or the event organizer's system. The venue ticketing system tracks the validity of the ticket and the ticket's barcode. Access to the venue and the event is controlled by physical or electronic tickets and the venue ticket system tracks the tickets as each ticket barcode is scanned for entry. Once a ticket-holder has the barcode on their ticket scanned at the time of entry into a venue in order to enter an event venue, the barcode is invalidated which grants the ticket-holder entry into the event venue.

Once a ticket is scanned for entry, the ticket's barcode is invalidated and the ticket-holder is granted entry into the venue with rights to sit in the seats specified on the ticket they used to enter into the venue. The scanning of the ticket barcode which invalidates the ticket's barcode instantaneously activates verified seat-rights associated with the scanned ticket for entry.

The information related to a verified seat and the ticket-holder's rights to the verified seat are stored by a system, such as the seatXchange system (“SX System”), that controls and manages the verified seat-rights from the time the ticket is scanned (such as when the ticket's barcode become invalid because it was used for entry) for entry until the end of the event. For clarity, use of the term “SX System” or “SX” shall refer to the system that manages and controls the verified seat-rights activated by the scan of a valid barcode upon entry and which continues to manage and control the verified seat-rights during the event until the event ends. However, it will apparent to those skilled in the art that the system controlling and managing verified seat-rights upon entry into an event and during the event may be incorporated as part of any other system or an independent system. For example, in accordance with the various aspects of the invention, the SX System is a computer system that can be integrated with or part the venue's system. In accordance with aspects of the invention, the SX System works independent of the venue and communicates therewith.

In accordance with an aspect of the invention and an embodiment of the invention, the system that manages or controls the verified seat-rights upon entry into the event and during the event is part of or integrated into the venue ticket system or the event organizer's system. In accordance with an aspect of the invention and an embodiment of the invention, the system that manages and controls verified seat-rights is independent from and in communication with the venue ticket system or the event organizer's system, which ever happens to be tracking ticket barcodes as the barcodes are scanned for entry into the event venue.

As a ticket's barcode is scanned in order to enter into the event venue, the seat associated with that ticket is verified and the system, such as the SX System, receives a notification that the seat is now a verified seat with seat-rights that can be verified and exchanged during the event. Thus, in accordance with the various aspects of the invention, when a ticket-holder's ticket is scanned for entry into a venue, the ticket's barcode is invalidated. Simultaneously, the ticket-holder's rights to the verified seat associated with the ticket used for entry is activated on the mobile device that was used to scan the ticket's barcode and can only be accessed on that mobile device unless an exchange is processed as described herein. In accordance with the various aspects of the invention and the embodiments of the invention, the system that manages and controls verified seat-rights is in direct communication with the ticket-holder's mobile device, such as the mobile phone or smart phone. Now the ticket-holder, upon entry into the venue, will have verified seat-rights that the ticket-holder can use as proof against anyone else claiming access to the verified seat associated with the ticket the ticketholder used to enter the venue. In accordance with various aspects of the invention, the verified seat holder can use the system, such as the SX System, that is controlling or managing the verified seat-rights to transfer or exchange seat-rights with someone else in the venue through an electronic exchange of seat and the associated verified seat-rights.

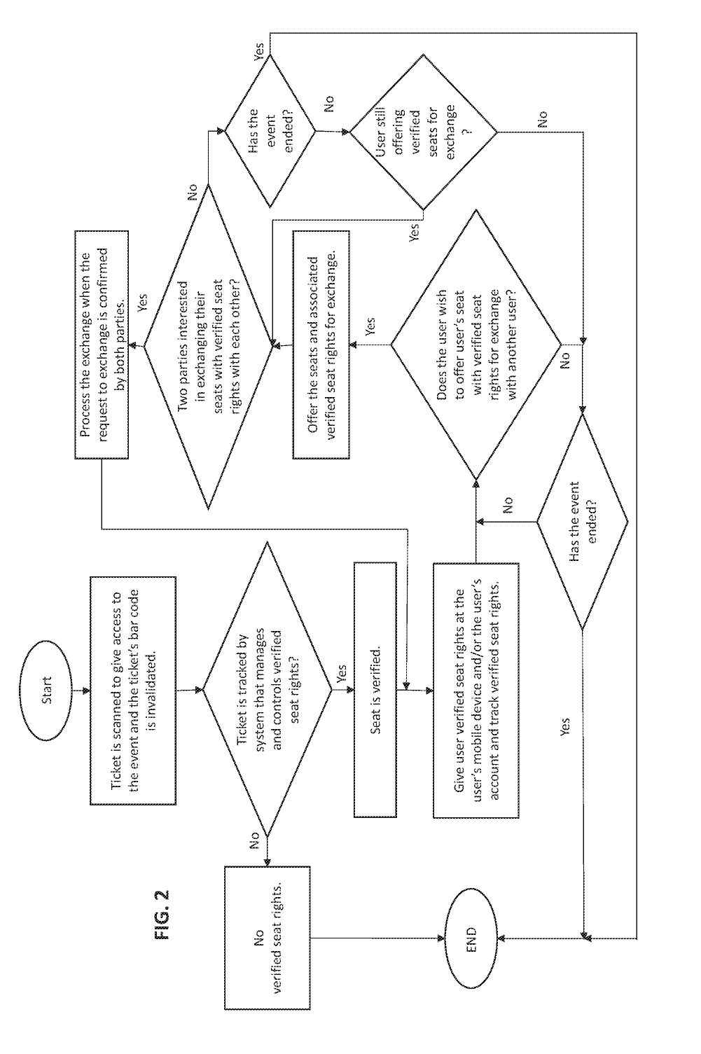

Referring now to FIG. 2, the process of verification of seat-rights is set forth. For example, consider a live-event taking place on November 30. The event starts at 7:00 p.m. and the event has an estimated end time of 10:30 p.m. Participant A (“A”) and Participant B (“B”) are both users of the system that controls and manages verified seat-rights, such as the SX system.

Referring again to FIGS. 2, A and B, before seeking entry into the Nov. 30, 2016 event, have uploaded their respective event tickets, or picture of hard tickets with the full barcode visible so that the barcode can be scanned for entry into the venue, into their respective SX accounts maintained by the SX System.

Continuing with FIG. 2, A has tickets for section 5 row 10 seats 1 and 2 and B has tickets for section 15 row 10 seats 1 and 2. Their tickets are tracked by the SX System because they have been uploaded into the SX System. Their tickets are viewable under the “My Tickets” menu of the SX System. A and a guest arrive at the November 30 event and upon entering the venue their tickets' barcodes are scanned thereby invalidating the tickets' barcodes upon entry. A's tickets no longer have an active barcode for access into the venue such that A, nor anyone else with a ticket bearing the same barcode on A's ticket, can use that barcode to gain entry into the venue for that event. If the tickets are not tracked by the SX System, i.e. not uploaded onto the SX System prior to the barcode being scanned for entry into the venue, then a verified seat-right is not generated upon entry to the event as the ticket's barcode is scanned. If the tickets are tracked by the SX System, then upon scanning of the barcode on the ticket to gain entry into the venue, the seat associated with the scanned barcode granting access into the venue is verified and verified seat-rights are available and a Verification Marker (as discussed below in paragraph [0042]) is placed on the visual presentation of the ticket on A's mobile device through the SX System. A and guest go to their seats in section 5 row 10 seats 1 and 2.

As used herein the term “Verification Marker” describes the following: at the time of entry into the venue, the SX System places a visual or audible marker, which is associated with the verified seat-rights granted by the ticket barcode used for entry into the venue that was stored on the mobile device of the user, including but not limited to a check mark, a watermark, a hologram, a photo, or an audible mark. In accordance with some aspects of the invention, the Verification Marker is unique to the mobile device that received the Verification Marker. The SX System is capable of tracking the unique association between the mobile device and the Verification Marker associated with the verified seat-rights and the visual presentation of the ticket on the mobile device. Accordingly, the SX System is capable of tracking the identification of the mobile device that is associated with the Verification Marker placed in the device. This allows the ticket-holder with the most current verified seat-rights, such as A or B, to present the Verification Marker to an usher to confirm seat-rights are valid and current at any time during the event.

B and guest arrive at the November 30 event and upon entering the venue their tickets' barcodes are scanned thereby invalidating the tickets' respective barcodes. B's tickets no longer have an active barcode for access to the venue. If the tickets are not tracked by the SX System, then a verified seat-right is not generated upon entry to the event as the ticket's barcode is scanned. If the tickets are tracked by the SX System, then upon scanning of the barcode on the ticket, the seat is verified and verified seat-rights are available and a Verification Marker is placed on the visual presentation of the ticket on B's mobile device. Upon entry, B and guest go to the section where their seats are located and show the usher their verified seats bearing Verification Marker and then sit in their seats in section 15 row 10 seats 1 and 2.

During the event, A decides he wants to exchange his seats with someone at the event so he and his guest can sit somewhere else in the venue for the rest of the event. He accesses the SX System and his verified seat-rights stored on his mobile device and he changes his seat settings from “Unavailable” to “Available.” In accordance with some aspects of the invention, the SX System may simultaneously checks A's location to ensure A is at the event location. Thus, in accordance with the various aspects of the invention, the SX System can determine location of A or B using GPS and the hand held mobile device in possession of A or B. Once the SX System confirms A's location, A then goes through the following selections to complete his seat exchange listing: What time his seats are available for exchange—immediately or in x minutes.

Then A views the venue's seating chart and selects:

a) the sections he wants to exchange with for an even exchange (neither user pays each other); and

b) the sections he would exchange with and the varying amount he would pay or demand for the exchange with seats in those sections.

A may also choose to indicate “All sections” and set a set price of $X regardless of the section.

If A selects “All sections,” then when setting the price, A has the option to set a fixed price or set his seats on an auction (with a minimum bid optional) and set a timer for how long the auction will run.

A selects that his seats are available immediately and that he is only interested in an even exchange (no exchange of cash) and would like to exchange seats with someone in sections 15, 16, or 17. A then completes his listing and his tickets are listed on the SX app inventory as verified seats and are searchable by other SX System users.

B also decides he wants to exchange seats during the event. B goes through the same listing process as A. B selects the seats are “available”; the SX System confirms B's location; B selects available immediately and that he is interested in (i) an even exchange with sections 5, 6, and 7, or (ii) $100 payment and seats in sections 8 and 9.

The SX System matches A's selections with B's selections. In accordance with one aspect of the invention, the SX System sends a push notification to A and B's phone notifying them of the match. In accordance with one aspect of the invention, the SX System sends a push notification to A; thereafter A initiates a notification to B's phone, thereby notifying B of the match. In accordance with one aspect of the invention, the SX System sends a push notification to B; thereafter B initiates a notification to A's phone, thereby notifying A of the match.

In accordance with one aspect of the invention, the SX System tracks history for both A and B and the history includes ratings, reviews, and other profile information. Thus, before deciding, A and B may review the other's profile and check their rating, reviews, and other profile information. A and B have the option of accepting, or rejecting the match.

If A or B rejects the “match” then the match is removed from both A and B's “match” list and each user is notified.

If one user, say A, accepts the match, then assuming A has entered his financial information and been verified by the SX System, then B is notified that A has accepted the “match.” B then has X minutes to accept the exchange or the exchange is cancelled. If B selects “accept” then so long as B's financial information has been provided and verified, then:

In accordance with one aspect of the invention, A and B are each charged $X per ticket exchanged. In accordance with one aspect of the invention, A and B are not charged per ticket exchanged;

User A's verified seat-rights, including electronic seats/picture of hard ticket are transferred to User B and User B's verified seat-rights, including electronic seats/picture of hard ticket are simultaneously transferred to User A. A now has verified seat-rights on his mobile device of B's former tickets that he received in the exchange from B; and B now has verified seat-rights on his mobile device of A's former tickets that he received in the exchange from A.

User A loses access to his previous verified seat-rights and electronic seats/picture of hard ticket and User B loses access to his previous verified seat-rights and electronic seats/picture of hard ticket.

In accordance with one aspect of the invention, seat access rights are tracked with encoded data or encrypted data, which may include but is not limited to the verification market as discussed above and herein or code, independent of the picture of the hard ticket. This data can be constant throughout the event or this data, in accordance with various aspects of the invention, can be dynamic.

The SX System automatically updates User A and User B's respective “My Tickets” section with their new seat information and Verification Marker for their new verified seats.

Simultaneously a transaction log is created in each user's “Transaction History” with a date and time stamp recording the transfer of seats and the same information is collected by the SX System for managing the verified seat-rights.

Simultaneously a chat box opens up between A and B. The chat box remains open for A and B to communicate with one another if A and B must meet to exchange physical tickets. A and B may select to turn on the GPS (using Newaer SDK) from within the chat to assist them in locating each other, if necessary.

The chat box disappears once each side confirms the transaction and rates each other or at the end of the event. User A or User B can report the other user if any violations of the SX System terms and conditions occur in the chat.

As used herein, the terms “data,” “content,” “information” and similar terms may be used interchangeably to refer to data capable of being transmitted, received and/or stored in accordance with the various aspects and embodiments of the invention. Thus, use of any such terms should not be taken to limit the spirit and scope of embodiments of the invention.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein.

Therefore, the scope of the invention, therefore, is not intended to be limited to the various aspects and embodiments discussed and described herein. Rather, the scope and spirit of invention is embodied by the appended claims.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A system for control and management of verified seat-rights, the system comprising:
a processor; and
a non-transitory computer-readable medium for storing code, which when executed by the processor, causes the system to:
process an upload of a ticket for an event, wherein the upload occurs before using a barcode of the ticket to get into the event;
activate verified seat-rights associated with the barcode of the ticket as the ticket is scanned to get into the event and the barcode of the ticket is invalidated;
generate a Verification Marker associated with the ticket's verified seat-rights; and
place the Verification Marker on an image of the ticket that is stored on a mobile device from which the barcode of the ticket was scanned.

2. The system of claim 1, wherein the system is integrated into a venue ticketing system.

3. The system of claim 1, wherein the system is independent of a venue ticketing system and is in communication with the venue ticketing system.

4. The system of claim 1, wherein the ticket's verified seat-rights are transferred from the mobile device to a second mobile device.

5. The system of claim 4, wherein the Verification Marker is transferred with the ticket's verified seat-rights.

6. The system of claim 4, wherein a transaction history is recorded on the mobile device and the system, the transaction history including unique transaction identification information for the transfer.

7. The system of claim 1, wherein the Verification Marker on the mobile device is used to gain access to the seat.

8. The system of claim 1, wherein the processor further causes the system to:
process an upload of a second ticket for the event, wherein the upload of the second ticket occurs before using a barcode of the second ticket to get into the event;
activate verified seat-rights associated with the barcode of the second ticket as the second ticket is scanned to get into the event and the barcode of the second ticket is invalidated;
generate a second Verification Marker associated with the second ticket's verified seat-rights; and
place the Verification Marker on an image of the second ticket that is stored on a second mobile device from which the barcode of the second ticket was scanned.

9. The system of claim 8, wherein the second ticket's verified seat-rights are transferred from the second mobile device to the mobile device.

10. The system of claim 9, wherein the second Verification Marker is transferred with the second ticket's verified seat-rights.

11. The system of claim 9, wherein a transaction history is recorded on the second mobile device and the system, the transaction history including unique transaction identification information for the transfer.

12. A method for control and management of verified seat-rights, the method comprising:
processing an upload of a ticket for an event, wherein the upload occurs before using a barcode of the ticket to get into the event;
activating verified seat-rights associated with the barcode of the ticket as the ticket is scanned to get into the event and the barcode of the ticket is invalidated;
generating a Verification Marker associated with the ticket's verified seat-rights; and
placing the Verification Marker on an image of the ticket that is stored on a mobile device from which the barcode of the ticket was scanned.

13. The method of claim 12, further comprising transferring the ticket's verified seat-rights from the mobile device to a second mobile device.

14. The method of claim 13, wherein the Verification Marker is transferred with the ticket's verified seat-rights.

15. The method of claim 13, further comprising recording a transaction history on the mobile device and a system, the transaction history including unique transaction identification information for the transfer.

16. The method of claim 12, wherein the Verification Marker on the mobile device is used to gain access to the seat.

17. The method of claim 12, further comprising:
processing an upload of a second ticket for the event, wherein the upload of the second ticket occurs before using the barcode of the second ticket to get into the event;
activating verified seat-rights associated with the barcode of the second ticket as the second ticket is scanned to get into the event and the barcode of the second ticket is invalidated;
generating a second Verification Marker associated with the second ticket's verified seat-rights; and
placing the Verification Marker on an image of the second ticket that is stored on a second mobile device from which the barcode of the second ticket was scanned.

18. The method of claim 17, further comprising transferring the second ticket's verified seat-rights from the second mobile device to the mobile device.

19. The method of claim 18, wherein the second Verification Marker is transferred with the second ticket's verified seat-rights.

20. The method of claim 18, further comprising recording a transaction history on the second mobile device and a system, the transaction history including unique transaction identification information for the transfer.
